(19) United States
(12) Patent Application Publication
(10) Pub. No.: US 2006/0078822 A1
(43) Pub. Date: Apr. 13, 2006

(54) Lithographic printing plate precursor requiring no dampening water

(75) Inventor: Koji Sonokawa, Haibara-gun (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/244,370

(22) Filed: Oct. 6, 2005

(30) Foreign Application Priority Data
Oct. 7, 2004 (JP) P. 2004-295295
Oct. 7, 2004 (JP) P. 2004-295296

(51) Int. Cl. G03C 1/76

(52) U.S. Cl. 430/270.1

(57) ABSTRACT

A lithographic printing plate precursor requiring no dampening water, which is prevented from the scratching of the non-image portion during the development processing step and the printing step to solve the problem of the ink stain on prints, is provided, which is a lithographic printing plate precursor requiring no dampening water comprising a support, a light-to-heat conversion layer and a silicone rubber layer, in this order, wherein the support is a support subjected to corona discharge treatment in an amount of 0.01 to 0.12 kW/m²/minute, and the light-to-heat conversion layer is directly provided on the support and contains carbon black having a dibutyl phthalate (DBP) oil absorption value of 111 ml/100 g or more or carbon black having an average particle size of primary particle of 25 to 75 nm.

### BACKGROUND OF THE INVENTION

1. Field of the Invention

The present invention relates to a high-sensitive lithographic printing plate precursor requiring no dampening water (hereinafter referred to as a “waterless lithographic printing plate precursor”) capable of forming an image by heat mode recording with a laser beam and printing without requiring dampening water, and more particularly to a waterless lithographic printing plate precursor excellent in scratch resistance.

2. Background Art

In conventional printing system requiring dampening water, it is difficult to control the delicate balance between dampening water and ink. Thus, emulsification of the ink and mixing of the ink in the dampening water occur to cause defect in ink density and background stain, which result in severe problems, for example, increase in paper spoilage. On the contrary, waterless lithographic printing plate precursors have many advantages because no dampening water is required in printing.

On the other hand, with the recent progresses of prepress system and output system, for example, image setter or laser printer, there have been provided methods for obtaining printing plates according to new plate-making processes, for example, computer-to-plate or computer-to-cylinder, using digitized data of printing image. Therefore, new types of printing materials for such systems have been desired and the developments thereof have been promoted.

Examples of the waterless lithographic printing plate precursor capable of conducting laser writing include a lithographic printing plate precursor comprising an ink-repellent silicone rubber layer provided on a layer that converts light to heat (hereinafter referred to as a “light-to-heat conversion layer”) composed of a layer containing a laser beam absorbing agent, for example, carbon black, and a binder or a metal thin layer When the lithographic printing plate precursor is irradiated with a laser beam, the silicone rubber layer is removed in the irradiated area to form an ink-receptive region (image portion) and the unirradiated silicone rubber remaining area forms an ink-repellent region (non-image portion), whereby it is possible to conduct waterless printing.

Such waterless lithographic printing plate precursors have advantages in that production cost is low and that since the image formation is performed utilizing ablation of the light-to-heat conversion layer in the laser-irradiated area, vapor generated pushes the silicone rubber layer in the laser-irradiated area so that removal of the silicone rubber layer (hereinafter also referred to as “development”) in the laser-irradiated area can be efficiently carried out.

Also, an embodiment is known where such a waterless lithographic printing plate precursor is fitted in the form of roll in a plate cylinder of a printing machine, the waterless lithographic printing plate precursor is supplied on the plate cylinder so as to face the printing surface of the waterless lithographic printing plate precursor upward, a new surface of the waterless lithographic printing plate precursor is spooled to place it in a printing region on the plate cylinder, imagewise laser scanning is carried out on the plate cylinder, the silicone rubber layer is removed in the laser-irradiated area, and then printing is conduced (see, for example, Patent Document 1: WO 90/02045).

However, such a waterless lithographic printing plate precursor is apt to make trouble of causing scratch on the non-image portion during the development processing step after the recording by laser writing and the printing step. For instance, in the case where the development processing is performed by a process of rubbing the plate surface with a developing pad impregnated with a development processing solution or a brush to remove the silicone rubber layer in the laser-irradiated area, fine crack and peeling occurs in the non-image portion due to dust attached to the developing pad or the like, thereby causing ink stain on prints.

In order to prevent the scratching of the silicone rubber layer, it is proposed to perform corona discharge treatment on a support and it is also described that condition of the corona discharge treatment (treating amount) of 1 to 200 W/m²/minute is effective (see, Patent Document 2: JP-A-11-245529 (the term “JP-A” as used herein means an “unexamined published Japanese patent application”.)).

However, according to the above-described technique, unnecessary damage and residue occur on the surface of the support and adhesion between the support and the light-to-heat conversion layer is deteriorated to cause scratching in the non-image portion, which may result in the ink stain on prints.

### SUMMARY OF THE INVENTION

Therefore, an object of the present invention is to solve the above-described problems in waterless lithographic printing plate precursors in which the image formation is performed utilizing ablation of the light-to-heat conversion layer in the laser-irradiated area.

Another object of the invention is to provide a waterless lithographic printing plate precursor which is prevented from the scratching of the non-image portion during the development processing step and the printing step to solve the problem of the ink stain on prints.

As a result of the intensive investigations, the inventors have found that it is important to define ranges of an amount of the corona discharge treatment to a support and a dibutyl phthalate (DBP) oil absorption value of carbon black incorporated into the light-to-heat conversion layer, or define ranges of an amount of the corona discharge treatment to a support and a particle size of primary particle of carbon black incorporated into the light-to-heat conversion layer, to complete the present invention.

Specifically, the present invention includes the following items,
(1) A lithographic printing plate precursor requiring no dampening water, comprising a support, a light-to-heat conversion layer and a silicone rubber layer, in this order, wherein the support is a support subjected to corona discharge treatment in an amount of 0.01 to 0.12 kW/m²/minute, and the flight-to-heat conversion layer is directly provided on the support and contains carbon black having a dibutyl phthalate (DBP) oil absorption value of 111 ml/100 g or more.
(2) A lithographic printing plate precursor requiring no dampening water, comprising a support, a light-to-heat conversion layer and a silicone rubber layer, in this order, wherein the support is a support subjected to corona discharge treatment in an amount of 0.01 to 0.12 kW/m²/minute, and the light-to-heat conversion layer is directly provided on the support and contains carbon black having an average particle size of primary particle of 25 to 75 nm.
(3) The lithographic printing plate precursor requiring no dampening water as described in (1) or (2) above, wherein the support is a polyethylene terephthalate subjected to a biaxial stretching treatment.
(4) The lithographic printing plate precursor requiring no dampening water as described in (1) or (2) above, wherein the amount of the corona discharge treatment is from 0.06 to 0.09 kW/m²minute.
(5) The lithographic printing plate precursor requiring no dampening water as described in (1) or (2) above, wherein an amount of the carbon black in the light-to-heat conversion layer is from 35% by weight or more based on a total solid content of the light-to-heat conversion layer.

The waterless lithographic printing plate precursor of the invention is able to perform printing preventing from the ink stain resulting from the scratching of the non-image portion during the development processing step and the printing step, also in an embodiment where the waterless lithographic printing plate precursor is fitted in the form of roll in a plate cylinder of a printing machine, the waterless lithographic printing plate precursor is supplied on the plate cylinder so as to face the image-forming surface of the waterless lithographic printing plate precursor upward, formation of an image pattern by scanning exposure of the image with an infrared laser beam based on digital signals and plate-making of the lithographic printing plate precursor are conducted on the printing machine, and printing is performed using the resulting printing plate on the printing machine.

According to the present invention, a waterless lithographic printing plate precursor capable of conducting printing without the formation of the ink stain resulting from the scratching of the non-image portion in an embodiment wherein an image pattern is formed by laser beam irradiation and removal of a silicone rubber layer in the irradiated area, and printing is conducted can be provided.

### DETAILED DESCRIPTION OF THE INVENTION

The waterless lithographic printing plate precursor according to the present invention will be described in detail below.

The configuration of the waterless lithographic printing plate precursor of the invention is described below. The waterless lithographic printing plate precursor according to the invention comprises a support having provided in order thereon at least a light-to-heat conversion layer and a silicone rubber layer. The terms “provided in order” as used herein means that these layers are provided in the above-described order, that the presence of other layer, for example, an overcoat layer or an intermediate layer is not negated and provided that the light-to-heat conversion layer is directly provided on the support. Further, on the opposite side of the support with respect to the light-to-heat conversion layer and the silicone rubber layer, a back layer may be provided.

Now, the support subjected to corona discharge treatment and the light-to-heat conversion layer containing carbon black, which are characteristic constituent elements of the waterless lithographic printing plate precursor according to the invention, are described in detail below.

[Support]

The support for use in the waterless lithographic printing plate precursor of the invention is required to have such flexibility that the lithographic printing plate precursor can be set on a conventional printing machine and to withstand the loading imposed during printing at the same time. Therefore, representative examples of the support used include a film of plastic, for example, polyester, e.g., polyethylene terephthalate or polyethylene-2,6-naphthalate, polyethylene, polypropylene, polystyrene, polyvinyl chloride, polyvinylidene chloride, polyvinyl alcohol, fluorine resin, polycarbonate, polyacetate, polyamide or polyimide, and a composite material of plastic with paper, metal or alloy (for example, coated paper laminated with polyethylene on both sides of paper or an aluminum sheet laminated with polyethylene terephthalate), but the invention should not be construed as being limited thereto. The plastic film may be any of unstretched, monoaxially stretched and biaxially stretched films, and is preferably a biaxially stretched polyethylene terephthalate film. The polyethylene terephthalate film containing voids as described in JP-A-9-314794 can be used.

In the invention, it is essential to conduct corona discharge treatment onto a surface of the support on which the light-to-heat conversion layer and silicone rubber layer are provided. The conditions of the corona discharge treatment are ordinarily expressed by a discharge amount per unit area and unit time. A practical range of the treating amount according to the invention is ordinarily from 0.01 to 0.12 kW/m²/minute, preferably from 0.06 to 0.09 kW/m²/minute. By controlling the treating amount of the corona discharge in the range and using the light-to-heat conversion layer in combination, which is another element of the invention as described hereinafter, scratch resistance of the non-image portion can be improved. The reason for this is believed to be that adhesion between the support and the light-to-heat conversion layer is improved by adjusting the treating amount to 0.01 kW/m²/minute or more, and by adjusting the treating amount to 0.12 kW/m²/minute or less, occurrence of unnecessary damage and residue on the surface of the support due to the corona discharge treatment is prevented so that deterioration in the adhesion between the support and the light-to-heat conversion layer can be avoided. On the contrary, when the treating amount of the corona discharge is out of the range of the invention, the scratch resistance of the non-image portion severely degrades and it is not preferable.

Thickness of the support used in the invention is suitably from 25 μm to 3 mm, preferably from 75 to 500 μm. An optimum thickness of the support may be varied depending on printing conditions. Ordinarily, thickness of 100 to 300 μm is most preferable.

[Light-to-Heat Conversion Layer]

The light-to-heat conversion layer for use in the waterless lithographic printing plate precursor of the invention is a layer having a function of converting an infrared laser beam used for writing to heat (light-to-heat conversion). The light-to-heat conversion layer is formed by dispersing a light-to-heat conversion agent having such a function in other component and coating the resulting dispersion.

According to one embodiment of the invention, carbon black having a dibutyl phthalate (DBP) oil absorption value of 111 ml/100 g or more is used as the light-to-heat conversion agent. The term “dibutyl phthalate (DBP) oil absorption value” as used herein means an absorption amount of DSBP per 100 g of carbon black when carbon black is added to DBP and measured using an absorpmeter described in JIS K6217, In some kinds of carbon black the DBP oil absorption value may be a little bit varied depending on its shape, specifically, powdery form or granular form. Unless otherwise indicated, however, the DBP oil absorption value used in the specification means a DBP oil absorption value of powdery carbon black.

The DSP oil absorption value can provide an indication of expressing an aggregation degree of primary particle of carbon black. The higher the DBP oil absorption value of carbon black, the higher the aggregation degree (the more the high structure). As the DBP oil absorption value decrease, the aggregation degree becomes lower.

Carbon blacks having a variety of the DBP oil absorption values are marketed. It is also known that the value has an influence on sensitivity of the plate material. More specifically, in the case of adding the same amount of carbon black, when the aggregation degree of primary particle thereof is high, a degree of blackness of the plate material does not increase so that an absorption rate of laser beam decreases, resulting in decrease in the sensitivity. Also, due to the aggregation of particles, a coating solution for light-to-heat conversion layer increases in viscosity or exhibits thixotropic nature and thus, handling of the coating solution becomes difficult and uniformity of the coated layer is impaired. On the other hand, when the DBP oil absorption value is low, dispersity of the carbon black decreases to result in decrease in the sensitivity. Therefore, it has been conventionally said that carbon black having the DBP oil absorption value ranging from 20 to 300 ml/100 g is preferably used. The inventors have found that the DBP oil absorption value affects the scratch resistance of the waterless lithographic printing plate precursor of the invention prepared by using the support subjected to corona discharge treatment. Although the mechanism brought the effect is not quite clear, it has been found that by controlling the DBP oil absorption value of carbon black to 111 ml/100 g or more, the adhesion between the light-to-heat conversion layer and the support subjected to corona discharge treatment is improved to increase the scratch resistance of the non-image portion. When the DSP oil absorption value is less than 111 ml/00 g, the scratch resistance of the non-image portion severely degrades and it is not preferable. A preferred range of the DSP oil absorption value of carbon blackis from 113 to 130 ml/100 g.

According to another embodiment of the invention, carbon black having an average particle size of primary particle of 25 to 75 nm is used as the light-to-heat conversion agent.

Carbon blacks having a variety of particle sizes are marketed. The inventors have found that the particle size of primary particle affects the scratch resistance of the waterless lithographic printing plate precursor of the invention prepared by using the support subjected to corona discharge treatment. Although the mechanism brought the effect is not quite clear, it has been found that by controlling the average particle size of primary particle of carbon black to 25 to 75 nm, the adhesion between the light-to-heat conversion layer and the support subjected to corona discharge treatment is improved to increase the scratch resistance of the non-image portion. When the particle size is out of the above-described range, the scratch resistance of the non-image portion severely degrades and it is not preferable. A range of the particle size of primary particle of carbon black is preferably from 28 to 65 nm, more preferably from 30 to 50 nm.

Examples of the carbon black include various carbon blacks, for example, acidic carbon black, basic carbon black or neutral carbon black, and various carbon blacks subjected to surface modification or surface coating for the purpose of improving dispersibility or the like.

According to the method of production, the carbon black is classified, for example, into furnace black, lamp black, channel black, roll black, disk black, thermal black or acetylene black. Among them, furnace black is preferably used because various kinds of furnace black with respect to particle size or the like are marketed and they are commercially available at a low cost.

Further, by using electrically conductive carbon black, the sensitivity of the plate material can be increased. In such a case, the electric conductivity of carbon black is preferably in a range of 0.01 to 100 Ω⁻¹cm⁻¹, more preferably in a range of 0.1 to 10 Ω⁻¹cm⁻¹. Specifically, Conductex 40-220, Conductex 975Beads, Conductex 900Beads, Conductex SC and Battery Black (manufactured by Columbian Carbon Japan, Ltd.), #3000 (manufactured by Mitsubishi Chemical Corp.), Denka Black (manufactured by Denki Kagaku Kogyo Kabusbiki Kaisha) and Vulcan XC-72R (manufactured by Cabot Corp.) are preferably used.

The amount of the light-to-heat conversion agent added to the light-to-heat conversion layer used in the invention is ordinarily 5% by weight or more, preferably 35% by weight or more, based on the total composition of the light-to-heat conversion layer, and the amount of the light-to-heat conversion agent is more preferably from 5 to 70% by weight, and particularly preferably from 35 to 50% by weight, based on the total composition of the light-to-heat conversion layer. To control the amount of the light-to-heat conversion agent added to 5% by weight or more prevents decrease in the sensitivity of the printing material, and to control it to 70% by weight or less prevents decrease in film strength of the light-to-heat conversion layer and decrease in the adhesion to the adjacent layer.

The light-to-heat conversion layer is ordinarily formed by dispersing the light-to-heat conversion agent into a binder together with other component, if desired, and coating the dispersion on the support. As the binder, known binders capable of dissolving or dispersing the light-to-heat conversion agent can be used. Examples of the binder include cellulose derivatives, for example, cellulose, nitro cellulose or ethyl cellulose, homopolymers or copolymers of acrylates, homopolymers or copolymers of methacrylates, for example, polymethyl methacrylates or polybutyl methacrylates, copolymers of acrylates and methacrylates, homopolymers or copolymers of styrene monomers, for example, polystyrene or poly-α-methylstyrene, various synthetic rubbers, for example, polyisoprene or styrene-butadiene copolymer, homopolymers of vinyl esters, for example, polyvinyl acetate, copolymers containing vinyl ester, for example, vinyl acetate-vinyl chloride copolymer or ethylene-vinyl acetate copolymer, various condensation series polymers, for example, polyureas, polyurethanes, polyesters or polycarbonates, and binders used in so-called “chemically amplified series” described in Frechet et al., J. Imaging Sci., 30(2), pages 59 to 64 (1986), Ito and Willson, Polymers in Electronics (Symposium Series), 242, page 11, T. Davidson, Ed., ACS Washington, D.C. (1984) and E. Reichmanis and L. F. Thompson, Microelectronic Engineering, 13, pages 3 to 10 (1991).

Among them, polyurethane resins are preferably used in view of adhesion to the silicone rubber layer described hereinafter. The polyurethane resin used in the light-to-heat conversion layer can be obtained by polyaddition reaction between a diisocyanate compound and a diol compound. Examples of the diisocyanate compound include aromatic diisocyanate compounds, for example, 2,4-tolylene diisocyanate, dimer of 2,4-tolylene diisocyanate, 2,6-tolylene diisocyanate, p-xylylene diisocyanate, m-xylylene diisocyanate, 4,4′-diphenylmethane diisocyanate, 4,4′-(2,2-diphenylpropane) diisocyanate, 1,5-naphthalene diisocyanate or 3,3′-dimethylbiphenyl-4,4′-diisocyanate; aliphatic diisocyanate compounds, for example, hexamethylene diisocyanate, trimethylhexamethylene diisocyanate, lysine diisocyanate or dimeric acid diisocyanate; alicyclic diisocyanate compounds, for example, isophorone diisocyanate, 4,4′-methylenebis(cyclohexyl isocyanate), methylcyclohexalne-2,4(or 2,6)-diisocyanate or 1,3-(isocyanatomethyl)cyclohexane; and diisocyanate compounds obtained by a reaction of diol with diisocyanate, for example, an adduct of 1 mole of 1,3-butylene glycol and 2 moles of tolylene diisocyanate.

Examples of the diol compound include ethylene glycol, diethylene glycol, triethylene glycol, tetraethylene glycol, polyethylene glycol, propylene glycol, 1,2-dipropylene glycol, 1,2-tripropylene glycol, 1,2-tetrapropylene glycol, 1,3-dipropylene glycol, polypropylene glycol, 1,3-butylene glycol, 1,3-dibutylene glycol, neopentyl glycol, 1,6-hexanediol, 2-butene-1,4-diol, 2,2,4-trimethyl-1,3-pentanediol, 1,4-bis-β-hydroxyethoxycyclohexane, cyclohexanedimethanol, tricyclodecanedimethanol, bisphenol A, hydrogenated bisphenol A, hydrogenated bisphenol F, bisphenol S, hydroquinone dihydroxy ethyl ether, p-xylylene glycol, dihydroxyetbylsulfone, 2,2′-dimethylol propanoic acid, bis(2-hydroxyethyl)-2,4tolylenedicarbamate, 2,4-tolylene-bis(2-hydroxyethylcarbamide), bis(2-hydroxyethyl)-m-xylylenedicarbamate and bis(2-hydroxyethyl)isophthalate. Polyethers obtained by a condensation reaction of the above-described diol compound and polyester diols obtained by a condensation reaction of a dicarboxylic acid compound, for example, adipic acid or terephthalic acid and the above-described diol compound are also exemplified. Further, in the synthesis of the polyurethane resin, a diamine compound or a chain-linking agent, for example, hydrazine or a hydrazine derivative may be used.

Polyurethanes described in JP-A-2001-188339 and JP-A-2002-144749 are particularly preferably used from the standpoint of the sensitivity and preservation stability of the photosensitive material.

The amount of the binder used in the light-to-heat conversion layer according to the invention is preferably from 10 to 95% by weight, more preferably from 40 to 80% by weight, based on the total solid content of the light-to-heat conversion agent.

Various kinds of additives can be added to the light-to-heat conversion layer according to various purposes, for example, for increasing mechanical strength of the light-to-heat conversion layer, increasing laser recording sensitivity, improving dispersibility of the light-to-heat conversion agent or the like in the light-to-heat conversion layer, or improving adhesion to a layer adjacent to the light-to-heat conversion layer, for example, an intermediate layer or a silicone rubber layer described hereinafter.

For instance, in order to increase the sensitivity, a light-to-heat conversion agent other than the above-described carbon black may be added- Examples of such a light-to-heat conversion agent include black pigments, e.g. nigrosines, aniline black or cyanine black, green pigments of phthalocyanine or naphthalocyanine series, carbon graphite, aluminum, iron powder, diamine series metal complexes, dithiol series metal complexes, phenolthiol series metal complexes, mercaptophenol series metal complexes, arylaluminum metal salts, inorganic compounds containing water of crystallization, copper sulfate, chromium sulfide, silicate compounds, metal oxides, e.g., titanium oxide, vanadium oxide, manganese oxide, iron oxide, cobalt oxide, tungsten oxide or indiumtin oxide, and hydroxides and sulfates of these metals, but the invention should not be construed as being limited thereto.

Besides the above, as organic dyes, various compounds described, for example, in Matsuoka, Infrared Sensitizing Dyes, Plenum Press, New York, N.Y. (1990), U.S. Pat. No. 4,833,124, European Patent 321,923, U.S. Pat. Nos. 4,772,583, 4,942,141, 4,948,776, 4,948,777, 4,948,778, 4,950,639, 4,912,083, 4,952,552 and 5,023,229, but the invention should not be construed as being limited thereto.

Further, in order to increase the laser recording sensitivity, known compounds capable of being decomposed by heating to generate gas can be added. In this case, the laser recording sensitivity is increased due to sudden cubical expansion of the light-to-heat conversion layer. Examples of the additive used include dinitrosopentamethylenetetraamine, N,N′-dimethyl-N,N′-dinitrosoterephthalamide, p-toluenesulfonyl hydrazide, 4,4-oxybis(benzenesulfonylhydrazide) and diamidobenzene. Further, in order to increase the laser recording sensitivity, known compounds (heat acid-generators) which are decomposed by heating to form acidic compounds, for example, various kinds of iodonium salts, sulfonium salts, phosphonium tosylate, oxime sulfonates, dicarbodiimide sulfonates or triazines, can be used as additives. The use of such a compound in combination with a chemically amplified type binder can greatly lower decomposition temperature of the chemically amplified type binder that is the constituent substance of the light-to-heat conversion layer, resulting in the increase in the laser recording sensitivity.

In order to improve the dispersion degree of the light-to-heat conversion agent including carbon black, various kinds of pigment dispersing agents can be used as additives. The amount of the pigment dispersing agent used in the invention is ordinarily from 1 to 70% by weight, preferably from 5 to 50% by weight, based on the light-to-heat conversion agent. When the amount added is 1% by weight or more, the effect of improving the dispersion degree of the pigment is exerted, thereby preventing the decrease in the sensitivity of plate material, whereas when the amount added is 70% by weight or less, the adhesion to the adjacent layer does not lower. In order to improve the adhesion to the adjacent layer, a known adhesion improver, for example, a silane coupling agent or a titanate coupling agent, or a binder exhibiting good adhesion to the adjacent layer, for example, an acrylate series resin containing vinyl group, an acrylate series resin containing hydroxy group, an acrylamide series resin or gelatin may be added. The amount of the adhesion improver or binder exhibiting good adhesion used in the invention is ordinarily from 5 to 70% by weight, preferably from 10 to 50% by weight, based on the total composition of the light-to-heat conversion layer. When the amount added is 5% by weight or more, the effect of improving the adhesion to the adjacent layer is exerted, whereas when the amount added is 70% by weight or less, the sensitivity of plate material does not lower.

In order to increase the mechanical strength of the light-to-heat conversion layer, various kinds of crosslinking agents capable of hardening the light-to-heat conversion layer Examples of the crosslinking agent include combinations of a polyfunctional isocyanate compound or a polyfunctional epoxy compound with a compound containing a hydroxy group, a carboxylic acid compound, a thiol series compound, an amine series compound or a urea series compound, but the invention should not be construed as being limited thereto. The amount of the crosslinking agent used in the invention is ordinarily from 1 to 50% by weight, preferably from 2 to 20% by weight, based on the total composition of the light-to-heat conversion layer. When the amount added is 1% by weight or more, the effect of crosslinking is exerted, whereas when the amount added is 50% by weight or less, the film strength of the light-to-heat conversion layer does not increase too much so that when external pressure is applied to the silicone rubber layer, the effect of acting as a shock absorber maintains to prevent deterioration of the scratch resistance.

In order to improve the coating property, a surfactant, for example, a fluorine series surfactant or a nonionic surfactant can be used as an additive. The amount of the surfactant used in the invention is ordinarily from 0.01 to 100% by weight, preferably from 0.05 to 1% by weight, based on the total composition of the light-to-heat conversion layer. When the amount added is 0.01% by weight or more, the coating property is improved to easily form a uniform light-to-heat conversion layer, whereas when the amount added is 10% by weight or less, the adhesion to the adjacent layer does not lower. Furthermore, various kinds of additives can be used, if desired.

The film thickness of the light-to-heat conversion layer used in the invention is ordinarily from 0.05 to 10 g/m³, preferably frorn 0.1 to 5 g/m³. The light-to-heat conversion layer used in the invention can be prepared by coating a coating solution for forming the light-to-heat conversion layer on the support by a conventionally known coating method, for example, a dip coating method, an air-knife coating method, a curtain coating method, a wire bar coating method, gravure coating method or an extrusion coating method, followed by drying.

[Silicone Rubber Layer]

The ink-repellent silicone rubber layer for use in the invention is prepared by reacting to a film layer of silicone rubber on the light-to-heat conversion layer. Specifically, it is preferably prepared by curing condensation type silicone with a crosslinking agent or addition polymerization of addition type silicone with a catalyst. In the case of using the condensation type silicone, it is preferable to use a composition comprising (a) 100 pails by weight of diorganopolysiloxane, (b) 3 to 70 parts by weight of a condensation type crosslinking agent and (c) 0.01 to 40 parts by weight of a catalyst. The above-described component (a), the diorganopolysiloxane, is a polymer having a repeating unit represented by the following formula: 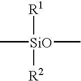
wherein R¹ and R² each represents an alkyl group having from 1 to 10 carbon atoms, a vinyl group or an aryl group, which may further have substituent(s). In general, it is preferred that 60% or more of R¹ and R² is occupied with a methyl group, a halogenated vinyl group or a halogenated phenyl group.

It is preferred that such a diorganopolysiloxane has hydroxy group at both terminals thereof The above-described component (a) preferably has a number average molecular weight of 3,000 to 600,000, and more preferably from 5,000 to 100,000. The crosslinking agent of component (b) may be any crosslinking agent as long as it is of the condensation type, but a compound represented by the following formula is preferred.
R¹ₘ—Si—Xₙ (m+n=4, n is 2 or more)
wherein R¹ has the same meaning as R¹ defined hereinabove, and X represents a halogen atom, for example, Cl, Br or I, a hydrogen atom, a hydroxy group or an organic substituent shown below. 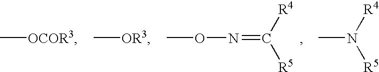
wherein R³ represents an alkyl group having from 1 to 10 carbon atoms or an aryl group having from 6 to 20 carbon atoms, and R⁴ and R⁵ each represents an alkyl group having from 1 to 10 carbon atoms.

The component (c) includes a known catalyst, for example, a carboxylate of metal (e.g., tin, zinc, lead, calcium or manganese), for example, dibutyl tin laurate, lead octylate or lead naphthenate, or chloroplatinic acid.

In the case of using the addition type silicone, it is preferable to use a composition comprising (d) 100 parts by weight of diorganopolysiloxane having addition reactive functional groups, (e) 0.1 to 25 parts by weight of organohydrogenpolysiloxane and (i) 0.00001 to 1 parts by weight of an addition catalyst. The above-described component (d), the diorganopolysiloxane having addition reactive functional groups, is an organopolysiloxane having at least two alkenyl groups (preferably, vinyl groups) directly bonded to the silicon atom in the molecule. The alkenyl group may be positioned either at a terminal of the molecule or at an intermediate portion thereof: The diorganopolysiloxane may have an unsubstituted or substituted alkyl group having from 1 to 10 carbon atoms or an unsubstituted or substituted aryl group, as an organic group other than the alkenyl group. Further, the component (d) may also contain hydroxyl groups in a slight amount, if desired. The number average molecular weight of the component (d) is preferably from 3,000 to 600,000, and more preferably from 5,000 to 150,000.

The component (e) includes, for example, polydimethylsiloxane having hydrogen atoms at the both terminals, α, ω-dimethylpolysiloxane, methylsiloxane-dimethylsiloxane copolymer having methyl groups at the both terminals, cyclic polymethylsiloxane, polymethylsiloxane having trimethylsilyl groups at the both terminals and dimethylsiloxane-methylsiloxane copolymer having trimethylsilyl groups at the both terminals.

Although the component (f) is appropriately selected from known polymerization catalysts, a platinum compound is particularly preferably used. Examples of the platinum compound include platinum, platinum chloride, chloroplatinic acid and olefin-coordinated platinum.

For the purpose of controlling the curing rate of the silicone rubber layer, it is also possible to add a crosslinking restraining agent, for example, organopolysiloxane containing a vinyl group, for example, tetracyclo(methylvinyl)siloxane, an alcohol containing a carbon-carbon triple bond, acetone, methyl ethyl ketone, methanol, ethanol and propylene glycol monomethyl ether.

The silicone rubber layer used in the invention can be formed by coating the composition containing the silicone described above using a solvent on the light-to-heat conversion layer, followed by drying. Since the film is formed by condensation reaction or addition reaction of the composition for the silicone rubber layer at drying of the solvent after the coating of the coating solution for forming the silicone rubber layer, when the drying temperature is low, it is feared that curing property of the silicone rubber decreases to result in curing defect. Therefore, the drying temperature of the silicone rubber layer after the coating is preferably 80° C. or more, and more preferably 100° C. or more.

The silicone rubber layer may contain an inorganic fine powder, for example, silica, calcium carbonate or titanium oxide, an adhesive auxiliary, for example, a silane coupling agent, a titanate coupling agent or an aluminum coupling agent or a photopolymerization initiator, if desired. The thickness of the silicone rubber layer used in the invention is preferably from 0.5 to 5.0 g/m², more preferably from 1.0 to 3.0 g/m², and still more preferably from 1.5 to 2.5 g/m². When the thickness is 0.5 g/m² or more, the ink repellency is not damaged and a problem, for example, generation of scratch does not cause, whereas when it is 5.0 g/m² or less, the developing property does not deteriorate. Moreover, for the purpose of improving printing durability, scratch resistance, image reproducibility or stain resistance, various silicone rubber layers may be further coated on the silicone rubber layer to form a surface layer.

[Back Layer]

In the waterless lithographic printing plate precursor according to the invention, at least one back layer is desirably provided on the opposite side of the support with respect to the light-to-heat conversion layer and the silicone rubber layer.

The back layer is not particularly restricted, but a layer containing electrically conductive metal oxide particles dispersed in a binder is preferably used.

The back layer-according to the invention may be a layer structure composed of two or more layers, if desired. When the back layer has the layer structure composed of two or more layers, all of these two or more layers may be collectively referred to as the back layer in the broad sense. Also, in the narrow sense, a lower layer may be referred to as a back layer and a upper layer may be referred to as an overcoat layer, or these layers may be referred to as a back first layer, a back second layer and the like in order from the lower layer. In the examples described hereinafter, they are referred to as a back first layer, a back second layer and the like.

The back layer may contain a matting agent. Further, the back layer may contain a surfactant or a lubricant, wax or like.

Examples of the matting agent include oxides, for example, silicon oxide, aluminum oxide or magnesium oxide and polymers or copolymers, for example, polymethyl methacrylate or polystyrene, preferably having an average particle size of 0.5 to 20 μm, and more preferably having an average particle size of 1.0 to 15 μm. In particular, crossliked particles of these polymers or copolymers are preferable.

By incorporating the matting agent into at least any one of the layers (back layer and/or overcoat layer) of the back layer side in a predetermined amount, Beck smoothness (second) of the surface of the back layer side can be adjusted from 50 to 500 seconds, preferably from 60 to 450 seconds, and more preferably from 200 to 400 seconds. The Beck smoothness (second) of the surface of the back layer side indicates a value measured according to the methods described in JIS P8 1 19-1998 and J. TAPPI, Paper pulp testing method No.5. When the Beck smoothness (second) of the surface of the back layer side is 50 seconds or more, concavity and convexity of the surface of the back layer side is not too large and the matting agent is hardly dropped from the layer, whereby transportability of the printing plate precursor does not degraded with the lapse of time. On the other hand, when the Beck smoothness (second) of the surface of the back layer side is 500 seconds or less, the smoothness of the back layer side is not too high and the transportability of the printing plate precursor does not decreases, whereby various harmful results due to the transportation defect do not occur.

The back layer may contain electrically conductive metal oxide particles. Materials of the electrically conductive metal oxide particles include, for example, ZnO, TiO₂, SnO₂, Al₂O₃, In₂O₃, MgO, BaO and MoO₃ and composite oxides thereof, and these metal oxides further containing foreign elements.

Of the metal oxides, SnO₂, ZnO, Al₂O₃, TiO₂, In₂O₃ and MgO are preferable, SnO₂, ZnO, In₂O₃ and TiO₂ are more preferable, and SnO₂ is particularly preferable. Examples of the metal oxide containing a small amount of foreign element include ZnO doped with Al or In, TiO₂ doped with Nb or Ta, In₂O₃ doped with Sn and SnO₂ doped with Sb, Nb or halogen, wherein the amount of the foreign element is from 0.01 to 30% by mole, preferably from 0.1 to 10% by mole. When the amount of the foreign element is 0.01% by mole or more, sufficient electric conductivity can be provided to the oxide or composite oxide, whereas when it is 30% by weight or less, increase of blackness of the particle is prevented so that the particle is suitable for the sensitive material because the back layer does not darken. Therefore, as the material for the electrically conductive metal oxide particle, the metal oxide or composite oxide containing a small amount of foreign element is preferably used in the invention Also, those having the oxygen defect in crystal structure thereof are preferable.

The content of the electrically conductive metal oxide particle is preferably in a range of 10 to 1,000%4 by weight, more preferably in a range of 100 to 800% by weight, based on the total amount of the binder in the back layer. When the content is 100% by weight or more, sufficient antistatic property is achieved, whereas when it is 1,000% by weight or less, dropout of the electrically conductive metal oxide particle from the light-sensitive material is prevented.

With respect to the particle size of the electrically conductive metal oxide particle, the smaller the particle size, the more preferable, in order to control light scattering as small as possible. It should be determined using a ratio of refractive indexes of the particle and binder as a parameter and can be obtained using Mie theory.

The average particle size of the metal oxide particle in the back layer of the waterless lithographic printing plate precursor of the invention is preferably from 0.001 to 0.5 μm, and more preferably from 0.003 to 0.2 μm The term “average particle size” as used herein means a value including not only a particle size of primary particle of the electrically conductive metal oxide but also a particle size of high order structure.

In order to add the fine particles of metal oxide to a coating solution for forming the back layer, although the particles may be added as they are to disperse, it is preferred that they are dispersed in a solvent, for example, water (including a dispersing agent or a binder, if desired) and the resulting dispersion is added to the coating solution.

According to the invention, by incorporating the metal oxide particle into the back layer, surface electric resistance of the back layer side of the lithographic printing plate precursor at 10° C. and 15% RH can be controlled to a range from 1×10⁷ to 1×10¹² Ω, preferably from 1×10⁹ to 1×10¹¹ Ω, and the surface electric resistance of the back layer under high temperature and high humidity conditions can also be controlled to the prescribed value. When the surface electric resistance of the back layer side of the lithographic printing plate precursor at 10° C. and 15% RH is controlled to 1×10⁷ or more, a large amount of the electrically conductive metal oxide particles is not requested and the dropout of the particles is prevented so that secondary failure, for example, formation of repelling nuclei in the coating layer due to the particles dropped out can be avoided. On the other hand, when it is 1×10¹² Ω or less, the desired antistatic property can be maintained under high temperature and high humidity conditions to prevent coating defect at the production of waterless lithographic printing plate precursor under high temperature and high humidity conditions. Also, deviation of focus of a laser beam at the image recording due to adhesion of dust on the waterless lithographic printing plate precursor is prevented and thus, sharpness (reproducibility) of image recording can be improved.

The binder for use in the back layer of the waterless lithographic printing plate precursor according to the invention is not particularly restricted and preferably includes a cured product of an acrylic resin and a melamine compound. In the invention, in view of maintaining favorable working environment and preventing air pollution, it is preferable that the acrylic resin and the melamine compound used are water-soluble, or that the acrylic resin and the melamine compound are used in the form of an aqueous dispersion, for example, an emulsion. Further, the acrylic resin preferably has any one of groups including a methylol group, a hydroxy group, a carboxy group and a glycidyl group, more preferably a hydroxy group or a carboxy group, and especially preferably a carboxy group, so as to enable the crosslinking reaction with the melamine compound The content of the hydroxy group or carboxy group in the acrylic resin is preferably from 0.0001 to 10 equivalent/1 kg, and especially preferably from 0.01 to 1 equivalent/1 kg.

Examples of the acrylic resin include a homopolymer of any one of monomers including acrylic acid, an acrylic ester, for example, an alkyl acrylate, acrylamide, acrylonitrile, methacrylic acid, a methacrylic ester, for example, an alkyl methacrylate, methacrylamide and methacrylonitrile and a copolymer obtained by polymerizing two or more of these monomers. Among them, a homopolymer of any one of monomers including an acrylic ester, for example, an alkyl acrylate and a methacrylic ester, for example, an alkyl methacrylate and a copolymer obtained by polymerizing two or more of these monomers are preferable. For example, a homopolymer of any one of monomers including an acrylic ester and a methacrylic ester each having an alkyl group containing from 1 to 6 carbon atoms and a copolymer obtained by polymerizing two or more of these monomers are exemplified.

The acrylic resin is a polymer, which is obtained by using mainly the above components and partially a monomer having any one of groups including, for example, a methylol group, a hydroxy group, a carboxy group and a glycidyl group so as to enable crosslinking reaction with the melamine compound.

Examples of the melamine compound used in the invention include a compound containing at least two (preferably at least three) methylol groups and/or alkoxymethyl groups in the molecule, and a melamine resin or a melamine-urea resin which is a condensation polymer thereof.

Examples of an initial condensation product of melamine and formalin include dimethylol melamine, trimethylol melamine, tetramethylol melamine, pentamethylol melamine and hexamethylol melamine. Specific examples of commercially available products thereof include Sumitex Resin M-3, Sumitex Resin MW, Sumitex Resin MK and Sumitex Resin MC (manufactured by Sumitomo Chemical Co., Ltd.), but the invention should not be construed as being limited thereto.

Examples of the condensation polymer include a hexamethylol melamine resin, a trimethylol melamine resin and a trimethylol trimethoxymethyl melamine resin. Examples of commercially available products thereof include MA-1 and MA-204 (manufactured by Sumitomo Bakelite Co., Ltd.), BECKAMENE MA-S, BECKAMINE APM and BECKAMINE J-101 (manufactured by Dainippon Ink & Chemicals, Inc.), Euroid 344 (manufactured by Mitsui Toatsu Chemicals, Inc.) and Oshika Resin M31 and Oshika Resin PWP-8 (manufactured by Oshika Shinko Co., Ltd.), but the invention should not be construed as being limited thereto.

The melamine compound preferably has a functional group equivalent of 50 to 300, which is a value obtained by dividing the molecular weight by the number of functional groups per molecule, wherein the functional group indicates a methylol group and an alkoxymethyl group. When the functional group equivalent is 300 or less, a curing density is appropriate to achieve high strength. When it is 50 or more, the curing density is appropriate and transparency is not damaged. The amount of the melamine compound added is from 0.1 to 100% by weight, preferably from 10 to 90% by weight, in terms of the acrylic resin.

The melamine compounds may be used individually or in combination of two or more thereof Further, the melamine compound can be used in combination with other compounds, for example, curing agents described, for example, in C. E. K. Mees and T. H. James, The Theory of the Photographic Process, Third edition, (1966), U.S. Pat. Nos. 3,316,095, 3,232,764, 3,288,775, 2,732,303, 3,635,718, 3,232,763, 2,732,316, 2,586,168, 3,103,437, 3,017,280, 2,983,611, 2,725,294, 2,725,295, 3,100,704, 3,091,537, 3,321,313, 3,543,292 and 3,125,449, and British Patents 994,869 and 1,167,207.

Typical examples of the curing agent include aldehyde compounds and derivatives thereof, for example, mucochloric acid, mucobromic acid, mucophenoxychloric acid, mucophenoxybromic acid, formaldehyde, glyoxal, monomethylglyoxal, 2,3-dihydroxy-1,4-dioxane, 2,3-dihydroxy-5-methyl-1,4-dioxane succinaldehyde, 2,5-dimethoxytetrahydrofuran and glutaraldehyde; active vinyl compounds, for example, divinylsulfone-N,N′-ethylenebis(vinylsulfonylacetamide), 1,3-bis(vinylsulfonyl)-2-propanol, methylenebismaleimide, 5-acetyl-1,3-diaayloylhexahydro-s-triazine, 1,3,5-triacryloylhexahydro-s-triazine and 1,3,5-trivinylsulfonylhexahydro-s-triazine; active halogen compounds, for example, sodium salt of 2,4-dichloro-6-hydroxy-s-triazine, sodium salt of 2,4-dichloro-6-(4sulfoanilino)-s-triazine, 2,4-dichloro-6-2-sulfoethylamino)-s-triazine and N,N′-bis(2-chloroethylcarbamyl)piperazine; epoxy compounds, for example, bis(2,3-epoxypropyl)methylpropyl ammonium p-toluenesufonate, 1,4-bis(2′,3′-epoxypropyloxy)butane, 1,3,5-triglycidyl isocyanurate, 1,3-diglycidyl-5-(γ-acetoxy-β-oxypropyl)isocyanurate, a sorbitol polyglycidyl ether, a polyglycerol polyglycidyl ether, a pentaerythritol polyglycidyl ether, a diglycerol polyglycidyl ether, 1,3,5-triglycidyl(2-hydroxyethyl)isocyanurate, a glycerol polyglycerol ether and a trimethylolpropane polyglycidyl ether; ethyleneimine compounds, for example, 2,4,6-triethylene-s-triazine, 1,6-hexamethylene-N,N′-bisethylene urea and bis-β-ethyleneiminoethyl thioether; methanesulfonate compounds, for example, 1,2-di(methanesulfonoxy)ethane, 1,4-di(methanesulfonoxy)butane and 1,5-di(methanesulfonoxy)pentane; carbodiimide compounds, for example, dicyclohexylcarbodiimide and 1-dicyclohexyl-3-(3-trimethylaminopropyl)carbodiimide hydrochloride; isoxazole compounds, for example, 2,5-dimethylisoxazole; inorganic compounds, for example, chromium alum and chromium acetate; dehydration condensation type peptide reagents, for example, N-carboethoxy-2-isopropoxy-1,2-dihydroquinoline and N-(1-morpholinocarboxy)-4-methylpyridinium chloride; active ester compounds, for example, N,N′-adipoyldioxydisuccinimide and N,N′-terephthaloyldioxydisuccinimide; isocyanates, for example, toluene2,4-diisocyanate and 1,6-hexamethylene diisocyanate; and epichlorohydrin compounds, for example, a polyamide-polyamine-epichlorohydrin reaction product; but the invention should not be construed as being limited thereto.

Examples of the surfactant include known anionic surfactants, catonic surfactants, amphoteric surfactants and nonionic surfactants.

Examples of the lubricant include a phosphoric ester of higher alcohol having from 8 to 22 carbon atoms and an amino salt thereof; palmitic acid, stearic acid and behenic acid and esters thereof, and a silicone compound.

The components described above are added to as they are or they are dispersed in a solvent, for example, water (including a dispersing agent or a binder, if desired) and the resulting dispersion is added to an aqueous dispersion or aqueous solution containing a binder and an appropriate additive and mixed with (and dispersed, if desired) to prepare a coating solution for forming the back layer, and the coating solution is coated and dried, thereby preparing the back layer.

The coating solution for forming the back layer can be coated on the surface (on which the light-to-heat conversion layer and the silicone rubber layer are not provided) of the support by an ordinarily well-known coating method, for example, a dip coating method, an air-knife coating method, a curtain coating method, a wire bar coating method, a gravure coating method or an extrusion coating method.

The thickness of the back layer is not particularly restricted and preferably in a range of 0.01 to 1 μm, more preferably in a range of 0.1 to 0.5 μm. When the thickness is 0.01 μm or more, it is easy to uniformly coat the coating solution to prevent the formation of coating irregularity in the product, whereas when it is 1 μm or less, the antistatic property and scratch resistance are not degraded.

[Plate-Making Method]

Now, a plate-making method where a lithographic printing plate is prepared from the waterless lithographic printing plate precursor of the invention is described. Similar to conventional plate-making methods, the plate-making includes an exposure step in which the adhesion of the silicone rubber layer to the adjacent layer is decreased by imagewise exposure in the exposed area and a development step in which the silicone rubber layer decreased in the adhesion is removed to form an ink-receptive region.

(I) Exposure Step

A laser beam used for exposure of the waterless lithographic printing plate precursor of the invention is required to provide an exposure amount to cause decrease in the adhesion sufficient for peeling and removing the silicone rubber layer. The kind of laser beam used is not particularly restricted, as long as the above condition is fulfilled, and a gas laser beam, for example, an Ar laser beam or a carbon dioxide gas laser beam, a solid laser beam, for example, a YAG laser beam, and a semiconductor laser beam can be used. Ordinarily, a laser beam having output of 50 mW or more is required. From the practical viewpoint of maintenance, cost or the like, a semiconductor laser beam and semiconductor-excited solid laser beam, for example, a YAG laser beam, are preferably employed. The recording wavelength of the laser beam is in an infrared region, and an oscillating wavelength of 800 to 1,100 an is often utilized. Also, the exposure can be carried out using an imaging device described in JP-A-6-186750 or a full-color printing system (Quickmaster DI46-4 (trade name) manufactured by Heidelberg).

(II) Development Step

As a developer used in the plate-making of a lithographic printing plate from the waterless lithographic printing plate precursor of the invention, known developers for waterless lithographic printing plate precursors, for example, a hydrocarbon, a polar solvent, water or a combination thereof can be used. However, in view of safety, water or an aqueous solution of organic solvent containing water as a main component is preferable. From the viewpoint of safety and inflammability, it is desirable that the concentration of organic solvent is 40% by weight or less. Examples of the hydrocarbon include an aliphatic hydrocarbon, for example, hexane, heptane, gasoline, kerosene, Isopar E, Isopar H or Isopar G (manufactured by Esso Chemical Co., Ltd.), an aromatic hydrocarbon, for example, toluene or xylene, and a halogenated hydrocarbon, for example, trichlene. Examples of the polar solvent include an alcohol, for example, methanol, ethanol, propanol, isopropanol, benzyl alcohol, ethylene glycol monomethyl ether, 2-ethoxyethanol, diethylene glycol monoethyl ether, diethylene glycol monohexyl ether, triethylene glycol monomethyl ether, propylene glycol monoethyl ether, dipropylene glycol monomethyl ether, polyethylene glycol monomethyl ether, polypropylene glycol or tetraethylene glycol, a ketone, for example, acetone, methyl ethyl ketone, an ester, for example, ethyl acetate, methyl lactate, butyl lactate, propylene glycol monomethyl ether acetate, diethylene glycol acetate or diethyl phthalate, and others, for example, triethyl phosphate or tricresyl phosphate. Also, water it self for example, tap water, pure water or distilled water can be used. The solvents may be used individually or in combination of two or more thereof. For example, the hydrocarbon to which water is added, the polar solvent to which water is added and a combination of the hydrocarbon and polar solvent are used. Further, when the hydrocarbon or polar solvent, which has low compatibility with water, is used, a surfactant or the like may be added to improve the solubility in water. Moreover, an alkali agent, for example, sodium carbonate, diethanolamine or sodium hydroxide may be added together with the surfactant.

The development can be performed according to known methods, for example, by rubbing the surface of the printing plate precursor with a developing pad impregnated with the developer as described above, or by pouring the developer on the surface of the printing plate precursor followed by rubbing the surface with a developing brush in water. The temperature of the developer can be appropriately set and is preferably from 10° C. to 50° C. Due to the development, the ink-repellent silicone rubber layer in the image portion is removed to form an ink-receptive region. The development processing described above or also the subsequent water washing and drying can be carried out with an automatic processor. A preferred example of the automatic processor is described in JP-A-2-220061. Also, the exposure and on-machine development can be continuously carried out under suitable conditions using the above-described full-color printing system (Quickmaster DI46-4 (trade name) manufactured by Heidelberg).

The waterless lithographic printing plate precursor of the invention can also be developed by laminating an adhesive layer on the surface of the silicon rubber layer followed by peeling the adhesive layer. Any of known adhesive layers which can adhere to the silicone rubber layer can be used. A product in which such an adhesive layer is provided on a flexible support is commercially available, for example, as Scotch Tape #851A (trade name) manufactured by Sumitomo 3M Ltd.

When the lithographic printing plates thus processed are stacked for storage, it is preferred to alternately put interleaves between the lithographic printing plates in order to protect them. The lithographic printing plate thus-obtained is mounted on a printing machine to provide a large number of good prints excellent in the ink-accepting property of the image portion.

### EXAMPLE

The present invention will be described in more detail with reference to the following examples, but the invention should not be construed as being limited thereto.

### Examples 1 to 34 and Comparative Examples 1 to 12

(Preparation of Back First Layer)

On a 180 μm-thick biaxially stretched polyethylene terephthalate film subjected to corona discharge treatment in an amount of 0.01 kW/m²/mitute was coated a coating solution shown below by a wire bar coating method, followed by drying at 180° C. for 30 seconds to prepare a back first layer having a dry thickness of 0.2 μm.

<Coating Solution for Back First Layer>

| | |
|---|---|
| Jurimer ET410 | 1.9 parts by weight |
| (aqueous dispersion of acrylic resin; solid | |
| content: 20% by weight; manufactured by | |
| Nihon Junyaku Co., Ltd.) | |
| Electrically conductive particle | 9.1 parts by weight |
| (aqueous dispersion of tin oxide-antimony oxide; | |
| average particle size: 0.05 μm; 17% | |
| by weight) | |
| Denacol EX-614B | 0.18 parts by weight |
| (epoxy compound; effective ingredient | |
| concentration: 100% by weight; manufactured | |
| by Nagase Chemtex Corp.) | |
| Sandet BL | 0.14 parts by weight |
| (aqueous solution of sodium alkylsulfonate; | |
| 44% by weight; manufactured by Sanyo | |
| Chemical Industries, Ltd.) | |
| Emalex 710 | 0.06 parts by weight |
| (polyoxyethylene alkyl ether: 100% by weight; | |
| manufactured by Nibon-Emulsion Co., | |
| Ltd.) | |
| Distilled water | 89 parts by weight |

(Preparation of Back Second Layer)

On the back first layer was coated a coating solution shown below by a wire bar coating method, followed by drying at 170° C. for 30 seconds to form a back second layer having a dry thickness of 0.07 μm.

<Coating Solution for Back Second Layer>

| | |
|---|---|
| Chemipearl S-120 | 1.6 parts by weight |
| (polyolefin latex, solid content: 27% by weight; | |
| manufactured by Mitsui Chemicals, Inc.) | |
| Snowtex C | 1.1 parts by weight |
| (colloidal silica; solid content: 20% by | |
| weight; manufactured by Nissan Chemical | |
| Industries, Ltd.) | |
| Sandet BL | 0.12 parts by weight |
| (aqueous solution of sodium alkylsulfonate; | |
| 44% by weight; manufactured by Sanyo | |
| Chemical Industries, Ltd.) | |
| Emalex 710 | 0.05 parts by weight |
| (polyoxyethylene alkyl ether: 100% by weight; | |
| manufactured by Nihon-Emulsion Co., | |
| Ltd.) | |
| Denacol EX-614B | 0.15 parts by weight |
| (epoxy compound; effective ingredient | |
| concentration: 100% by weight; manufactured | |
| by Nagase Chemtex Corp.) | |
| Chemipearl W-950 | 0.04 parts by weight |
| (polyolefin matting agent, solid content: | |
| 40% by weight; manufactured by Mitsui | |
| Chemicals, Inc.) | |
| Distilled water | 97 parts by weight |

(Preparation of Light-to-Heat Conversion Layer)

A mixture shown below was stirred together with glass beads in a paint shaker for 30 minutes to disperse carbon black, and after removing the glass beads by filtration, 0.005 g of surfactant KF 333 (manufactured by Dainippon Ink & Chemicals, Inc.) was added thereto, followed by stirring to prepare a coating solution for light-to-heat conversion layer.

After conducting corona discharge treatment in a treating amount shown in Table 1 below on the opposite side of the support with respect to the back layer, the coating solution was coated by a wire bar coating method so as to form a layer having a dry thickness of 1.0 μm, followed by drying at 150° C. for one minute to prepare a light-to-heat conversion layer.

<Coating Solution for Light-to-Heat Conversion Layer>

| | |
|---|---|
| Polyurethane | 3.0 parts by weight |
| (reaction product of 5 moles of diphenylmethane | |
| diisocyanate, 1 mole of polypropylene | |
| glycol and 4 moles of 2,2′-dimethylolpropanoic | |
| acid) | |
| Carbon black | amount shown in |
| (shown in Tables 1 and 2) | Tables 1 and 2 |
| Solsperse S24000R (manufactured by ICI) | 0.15 parts by weight |
| Solsperse S17000 (manufactured by ICI) | 0.15 parts by weight |
| Methyl ethyl ketone | 29 parts by weight |
| Propylene glycol monomethyl ether | 15 parts by weight |

(Preparation of Silicone Rubber Layer)

A coating solution shown below was coated on the light-to-heat conversion layer and dried at 150° C. for one minute to prepare an addition type silicone rubber layer having a dry thickness of 1.5 g/m².

<Coating Solution for Silicone Rubber Layer>

| | |
|---|---|
| FS-42 | 9.0 parts by weight |
| (α,ω-divinylpolydimethylsiloxane; | |
| average polymerization degree: 1,300; | |
| manufactured by Shin-Etsu Chemical Co., Ltd.) | |
| (CH₃)₃SiO(SiH(CH₃)O)₈—Si(CH₃)₃ | 0.2 parts by weight |
| Olefin-coordinated platinum catalyst | 0.1 part by weight |
| Controlling agent | 0.2 parts by weight |
| (HC≡C—C(CH₃)₂—O—Si(CH₃)₃) | |
| Isopar E | 120.0 parts by weight |
| (manufactured by Exxon Chemical) | |

Thus, the waterless lithographic printing plate precursors for use in Examples 1 to 34 and Comparative Examples 1 to 12 were prepared.

TABLE 1

| | | Carbon Black in Light-To-Heat Conversion Layer | | |
|---|---|---|---|---|
| | Support | | DBP Oil | Amount |
| | Corona Discharge | | Absorption | Added |
| | Treatment Amount | | Value | (part by |
| Sample | (kW/m²/mitute) | Species | (ml/100 g) | weight) |
| Example 1 | 0.05 | #990 (manufactured by | 112 | 2.0 |
| | | Mitsubishi Chemical | | |
| | | Corp.) | | |
| Example 2 | 0.08 | #990 (manufactured by | 112 | 2.0 |
| | | Mitsubishi Chemical | | |
| | | Corp.) | | |
| Example 3 | 0.02 | MA-230 (manufactured | 113 | 2.0 |
| | | by Mitsubishi Chemical | | |
| | | Corp.) | | |
| Example 4 | 0.03 | MA-230 (manufactured | 113 | 2.0 |
| | | by Mitsubishi Chemical | | |
| | | Corp.) | | |
| Example 5 | 0.05 | MA-230 (manufactured | 113 | 2.0 |
| | | by Mitsubishi Chemical | | |
| | | Corp.) | | |
| Example 6 | 0.08 | MA-230 (manufactured | 113 | 2.0 |
| | | by Mitsubishi Chemical | | |
| | | Corp.) | | |
| Example 7 | 0.11 | MA-230 (manufactured | 113 | 2.0 |
| | | by Mitsubishi Chemical | | |
| | | Corp.) | | |
| Example 8 | 0.05 | #20 (manufactured by | 121 | 2.0 |
| | | Mitsubishi Chemical | | |
| | | Corp.) | | |
| Example 9 | 0.08 | #20 (manufactured by | 121 | |
| | | Mitsubishi Chemical | | |
| | | Corp.) | | |
| Example 10 | 0.05 | MA-600 (manufactured | 131 | 2.0 |
| | | by Mitsubishi Chemical | | |
| | | Corp.) | | |
| Example 11 | 0.08 | MA-600 (manufactured | 131 | 2.0 |
| | | by Mitsubishi Chemical | | |
| | | Corp.) | | |
| Example 12 | 0.08 | MA-230 (manufactured | 113 | 1.6 |
| | | by Mitsubishi Chemical | | |
| | | Corp.) | | |
| Example 13 | 0.08 | MA-230 (manufactured | 113 | 1.8 |
| | | by Mitsubishi Chemical | | |
| | | Corp.) | | |
| Example 14 | 0.08 | MA-230 (manufactured | 113 | 2.2 |
| | | by Mitsubishi Chemical | | |
| | | Corp.) | | |
| Example 15 | 0.08 | MA-230 (manufactured | 113 | 2.4 |
| | | by Mitsubishi Chemical | | |
| | | Corp.) | | |
| Comparative | 0.05 | MA-100 (manufactured | 100 | 2.0 |
| Example 1 | | by Mitsubishi Chemical | | |
| | | Corp.) | | |
| Comparative | 0.08 | MA-100 (manufactured | 100 | 2.0 |
| Example 2 | | by Mitsubishi Chemical | | |
| | | Corp.) | | |
| Comparative | 0.05 | #40 (manufactured by | 110 | 2.0 |
| Example 3 | | Mitsubishi Chemical | | |
| | | Corp.) | | |
| Comparative | 0.08 | #40 (manufactured by | 110 | 2.0 |
| Example 4 | | Mitsubishi Chemical | | |
| | | Corp.) | | |
| Comparative | 0.005 | MA-230 (manufactured | 113 | 2.0 |
| Example 5 | | by Mitsubishi Chemical | | |
| | | Corp.) | | |
| Comparative | 0.15 | MA-230 (manufactured | 113 | 2.0 |
| Example 6 | | by Mitsubishi Chemical | | |
| | | Corp.) | | |

TABLE 2

| | Support | | | |
|---|---|---|---|---|
| | Corona | Carbon Black in Light-To-Heat Conversion Layer | | |
| | Discharge | | | Amount |
| | Treatment | | Average Particle | Added |
| | Amount | | Size of Primary | (part by |
| Sample | (kW/m²/mitute) | Species | Particle (nm) | weight) |
| Example 16 | 0.06 | #52 (manufactured by | 27 | 2.0 |
| | | Mitsubishi Chemical Corp.) | | |
| Example 17 | 0.09 | #52 (manufactured by | 27 | 2.0 |
| | | Mitsubishi Chemical Corp.) | | |
| Example 18 | 0.06 | #50 (manufactured by | 28 | 2.0 |
| | | Mitsubishi Chemical Corp.) | | |
| Example 19 | 0.09 | #50 (manufactured by | 28 | 2.0 |
| | | Mitsubishi Chemical Corp.) | | |
| Example 20 | 0.01 | MA-230 (manufactured by | 30 | 2.0 |
| | | Mitsubishi Chemical Corp.) | | |
| Example 21 | 0.04 | MA-230 (manufactured by | 30 | 2.0 |
| | | Mitsubishi Chemical Corp.) | | |
| Example 22 | 0.06 | MA-230 (manufactured by | 30 | 2.0 |
| | | Mitsubishi Chemical Corp.) | | |
| Example 23 | 0.09 | MA-230 (manufactured by | 30 | 2.0 |
| | | Mitsubishi Chemical Corp.) | | |
| Example 24 | 0.12 | MA-230 (manufactured by | 30 | |
| | | Mitsubishi Chemical Corp.) | | |
| Example 25 | 0.06 | #20 (manufactured by | 50 | 2.0 |
| | | Mitsubishi Chemical Corp.) | | |
| Example 26 | 0.09 | #20 (manufactured by | 50 | 2.0 |
| | | Mitsubishi Chemical Corp.) | | |
| Example 27 | 0.06 | MA-230 (manufactured by | 55 | 2.0 |
| | | Mitsubishi Chemical Corp.) | | |
| Example 28 | 0.09 | MA-230 (manufactured by | 55 | 2.0 |
| | | Mitsubishi Chemical Corp.) | | |
| Example 29 | 0.06 | #10 (manufactured by | 75 | 2.0 |
| | | Mitsubishi Chemical Corp.) | | |
| Example 30 | 0.09 | #10 (manufactured by | 75 | 2.0 |
| | | Mitsubishi Chemical Corp.) | | |
| Example 31 | 0.06 | MA-230 (manufactured by | 30 | 1.6 |
| | | Mitsubishi Chemical Corp.) | | |
| Example 32 | 0.06 | MA-230 (manufactured by | 30 | 1.8 |
| | | Mitsubishi Chemical Corp.) | | |
| Example 33 | 0.06 | MA-230 (manufactured by | 30 | 2.2 |
| | | Mitsubishi Chemical Corp.) | | |
| Example 34 | 0.06 | MA-230 (manufactured by | 30 | 2.4 |
| | | Mitsubishi Chemical Corp.) | | |
| Comparative | 0.06 | #40 (manufactured by | 24 | 2.0 |
| Example 7 | | Mitsubishi Chemical Corp.) | | |
| Comparative | 0.09 | #40 (manufactured by | 24 | 2.0 |
| Example 8 | | Mitsubishi Chemical Corp.) | | |
| Comparative | 0.06 | #5 (manufactured by | 76 | 2.0 |
| Example 9 | | Mitsubishi Chemical Corp.) | | |
| Comparative | 0.09 | #5 (manufactured by | 76 | 2.0 |
| Example 10 | | Mitsubishi Chemical Corp.) | | |
| Comparative | 0.005 | MA-230 | 30 | 2.0 |
| Example 11 | | (manufactured by Mitsubishi | | |
| | | Chemical Corp.) | | |
| Comparative | 0.15 | MA-230 | 30 | 2.0 |
| Example 12 | | (manufactured by Mitsubishi | | |
| | | Chemical Corp.) | | |

[Evaluation of Waterless Lithographic Printing Plate Precursor]
(Model Evaluation of Scratch Resistance)

Each of the waterless lithographic printing plate precursors according to the invention and those for comparisons was subjected to formation of halftone dot images of 1,751 pi (1,270 dpi) by a plate setter (PEARLsetter; loaded with semiconductor laser (wavelength: 830 nm, beam diameter: 28 μm (1/e²), maximum output: 750 mW); manufactured by Presstek Inc.). Then, the surface of the printing plate precursor was rubbed with a developing pad impregnated with Processing Solution 1 having the composition shown below to remove the silicone rubber layer in the laser-irradiated area. As a result, a waterless lithographic printing plate having silicone images reproducing a halftone dot area ratio of 2 to 98% with sharp edges was obtained.

<Processing Solution 1>

| | |
|---|---|
| Polyoxyethylene sorbitanmonooleate | 5 g |
| (Reodol TW-O106; manufactured by Kao Corp.) | |
| Water stain inhibitor | 2 g |
| (BK2; manufactured by Fuji Photo Film Co., Ltd.) | |
| Water | 993 g |

In order to evaluate the scratch resistance of the waterless lithographic printing plate thus-obtained, the waterless lithographic printing plate was subjected to scratching test with a 0.5-mm Φ sapphire needle while changing a load every 50 g from 50 to 500 g using a HEIDON-14 (Surface Nature Measuring Machine; manufactured by Shinto Scientific Co., Ltd.). Using the waterless lithographic printing plate subjected to the scratching test, printing was conducted printing machine: Daiya 1F-2, manufactured by Mitsubishi Heavy Industries, Ltd.; ink: Aqualess Echo New M Black; manufactured by Toyo Ink Mfg. Co., Ltd.; cooling of ink-supplying roller: 20° C.). After printing 500 sheets, the occurrence of ink stain in the scratched region of the non-image portion was observed on the print, and the load applied to the sapphire needle by which the ink stain begun to occur on the print was determined to use as an index of the evaluation of scratch resistance. The results obtained are shown in Tables 3 and 4.

TABLE 3

| | Model Evaluation of Scratch Resistance |
|---|---|
| Sample | (load by which ink stain begun to occur) |
| Example 1 | 450 g |
| Example 2 | 500 g |
| Example 3 | 450 g |
| Example 4 | 450 g |
| Example 5 | No Ink stain occurred |
| Example 6 | No Ink stain occurred |
| Example 7 | 500 g |
| Example 8 | 500 g |
| Example 9 | No Ink stain occurred |
| Example 10 | 450 g |
| Example 11 | 500 g |
| Example 12 | 500 g |
| Example 13 | No Ink stain occurred |
| Example 14 | 500 g |
| Example 15 | 450 g |
| Comparative Example 1 | 50 g |
| Comparative Example 2 | 50 g |
| Comparative Example 3 | 50 g |
| Comparative Example 4 | 100 g |
| Comparative Example 5 | 50 g |
| Comparative Example 6 | 100 g |

TABLE 4

| | Model Evaluation of Scratch Resistance |
|---|---|
| Sample | (load by which ink stain begun to occur) |
| Example 16 | 450 g |
| Example 17 | 450 g |
| Example 18 | 500 g |
| Example 19 | 500 g |
| Example 20 | 400 g |
| Example 21 | 500 g |
| Example 22 | No Ink stain occurred |
| Example 23 | No Ink stain occurred |
| Example 24 | 450 g |
| Example 25 | No Ink stain occurred |
| Example 26 | No Ink stain occurred |
| Example 27 | 500 g |
| Example 28 | 500 g |
| Example 29 | 400 g |
| Example 30 | 400 g |
| Example 31 | 400 g |
| Example 32 | 450 g |
| Example 33 | No Ink stain occurred |
| Example 34 | 500 |
| Comparative Example 7 | 100 g |
| Comparative Example 8 | 100 g |
| Comparative Example 9 | 50 g |
| Comparative Example 10 | 50 g |
| Comparative Example 11 | 50 g |
| Comparative Example 12 | 100 g |

As is apparent from the results shown in Tables 3 and 4, the waterless lithographic printing plate precursors of Examples 1 to 34 according to the invention exhibit good scratch resistance. On the contrary, the waterless lithographic printing plate precursors of Comparative Examples 1 to 12 provide unsatisfactory results.

(Practical Evaluation of Scratch Resistance)

Each of the waterless lithographic printing plate precursors according to the invention and those for comparisons was formed into a roll and loaded in a full-color printing system machine (Quickmaster DI46-4 pro; manufactured by Heidelberg). Then, on the printing machine, exposure, removal of the silicone rubber layer in the exposed area and printing (ink: Aqualess Echo New M Black; manufactured by Toyo Ink Mfg. Co., Ltd.). After printing 20,000 sheets, the occurrence of ink stain due to the scratch in the non-image portion was observed on the print. As a result, the ink sun was not occur at all and good prints were obtained as for the waterless lithographic printing plates of the examples, although two spots of ink stain on average occurred per plate in the waterless lithographic printing plates of the comparative examples.

This application is based on Japanese patent applications JP 2004-295295, filed on Oct. 7, 2004 and JP 2004-295296, filed on Oct. 7, 2004, the entire content of which is hereby incorporated by reference, the same as if set forth at length.

What is claimed is:

1. A lithographic printing plate precursor requiring no dampening water, comprising a support, a light-to-heat conversion layer and a silicone rubber layer, in this order, wherein the support is a support subjected to corona discharge treatment in an amount of 0.01 to 0.12 kW/m²/minute, and the light-to-heat conversion layer is directly provided on the support and contains carbon black having a dibutyl phthalate (DBP) oil absorption value of 111 ml/100 g or more.

2. A lithographic printing plate precursor requiring no dampening water, comprising a support, a light-to-heat conversion layer and a silicone rubber layer, in this order, wherein the support is a support subjected to corona discharge treatment in an amount of 0.01 to 0.12 kW/m²/minute, and the light-to-heat conversion layer is directly provided on the support and contains carbon black having an average particle size of primary particle of 25 to 75 nm.

3. The lithographic printing plate precursor requiring no dampening water as claimed in claim 1, wherein the support is a polyethylene terephthalate subjected to a biaxial stretching treatment.

4. The lithographic printing plate precursor requiring no dampening water as claimed in claim 1, wherein the amount of the corona discharge treatment is from 0.06 to 0.09 kW/m²/minute.

5. The lithographic printing plate precursor requiring no dampening water as claimed in claim 1, wherein an amount of the carbon black in the light-to-heat conversion layer is from 35% by weight or more based on a total solid content of the light-to-heat conversion layer.

6. The lithographic printing plate precursor requiring no dampening water as claimed in claim 2, wherein the support is a polyethylene terephthalate subjected to a biaxial stretching treatment.

7. The lithographic printing plate precursor requiring no dampening water as claimed in claim 2, wherein the amount of the corona discharge treatment is from 0.06 to 0.09 kW/m²/minute.

8. The lithographic printing plate precursor requiring no dampening water as claimed in Claim 2, wherein an amount of the carbon black in the light-to-heat conversion layer is from 35% by weight or more based on a total solid content of the light-to-heat conversion layer.
